(19) United States
(12) Patent Application Publication
(10) Pub. No.: US 2014/0376333 A1
(43) Pub. Date: Dec. 25, 2014

(54) SYSTEMS AND METHODS FOR REDUCING FALSE TARGETS IN ULTRASONIC RANGE SENSING APPLICATIONS

(71) Applicant: Topcon Positioning Systems, Inc., Livermore, CA (US)

(72) Inventors: Larry Larson, San Jose, CA (US); Matthew Harman, Stockton, CA (US)

(73) Assignee: Topcon Positioning Systems, Inc., Livermore, CA (US)

(21) Appl. No.: 13/923,711

(22) Filed: Jun. 21, 2013

(51) Int. Cl. G01S 7/523

(52) U.S. Cl. CPC G01S 7/523
USPC 367/99

(57) ABSTRACT

An ultrasonic range sensor comprises at least one transducer adapted to generate an ultrasonic pulse having a first axis of transmission and detect a reflected signal that is associated with the ultrasonic pulse and propagates along the first axis of transmission. The ultrasonic range sensor also comprises a deflecting region adapted to reflect the reflected signal along a second axis different from the first axis of transmission. In one embodiment, the second axis is deflected from the first axis by a non-zero angle determined by a characteristic of the deflecting region.

### TECHNICAL FIELD

This application relates generally to range sensing and more particularly to systems and methods for reducing false targets in ultrasonic range sensing applications.

### BACKGROUND

In construction using asphalt and concrete materials (e.g., road finishing, paving, etc.), various systems and methods for sensing the distance to a surface (e.g., a road) have been used. For example, contacting and non-contacting systems have been used. Contacting systems are prone to damage and breakage. Non-contacting systems generally employ a range sensor, such as an ultrasonic sensor, to measure the distance from a construction vehicle or sensing unit to the road surface. Typically, one or more pulses are transmitted and a reflection generated by the surface is detected and measured to determine a distance to the surface. In some systems more than one homogenous sensor is used to measure distances to the surface from the sensing unit. Multiple measurements may be averaged to determine an approximate distance between the sensing mechanism and the surface.

However, reflections associated with a primary pulse can be reflected by the surface of the sensor itself, causing transmission of a “secondary pulse” which can generate further “secondary reflections.” Secondary reflections are generally undesired signals and, for example, can cause an ultrasonic sensor to perceive one or more false targets during an ultrasonic sensing operation. An ultrasonic range sensor may need to use processing resources to filter out secondary reflections in order to accurately measure the distance from the sensor to a selected surface. Accordingly, there is a need for improved ultrasonic range systems capable of eliminating or reducing secondary pulses and/or secondary reflections.

### SUMMARY

In accordance with an embodiment, an ultrasonic range sensor is provided. The ultrasonic range sensor comprises at least one transducer adapted to generate an ultrasonic pulse having a first axis of transmission and detect a reflected signal that is associated with the ultrasonic pulse and propagates along the first axis of transmission. The ultrasonic range sensor also comprises a deflecting region adapted to reflect the reflected signal along a second axis different from the first axis of transmission. In one embodiment, the second axis is deflected from the first axis by a non-zero angle determined by a characteristic of the deflecting region.

In one embodiment, the deflecting region comprises a plurality of parallel ridges, the plurality of ridges being perpendicular to the first axis of transmission.

In another embodiment, the ultrasonic range sensor comprises two transducers. The deflecting region and the two transducers are disposed on a surface of the ultrasonic range sensor, and the deflecting region is disposed between the two transducers. The plurality of parallel ridges are parallel to a third axis between a first center of the first transducer and a second center of the second transducer.

In one embodiment, the transducers generate an ultrasonic pulse having a wavelength. The width of each of the plurality of ridges is at least one-fourth the wavelength.

In another embodiment, the deflecting region comprises a plurality of cones. In another embodiment, the deflecting region comprises a plurality of domes.

In another embodiment, the ultrasonic range sensor comprises a processor adapted to determine a distance between the ultrasonic range sensor and a surface based on the reflected signal.

In accordance with another embodiment, a method of operation of an ultrasonic range sensor is provided. An ultrasonic pulse is transmitted along a first axis. A reflected signal associated with the ultrasonic pulse is received along the first axis. The reflected signal is reflected, by a deflecting region disposed on a surface of the ultrasonic range sensor, along a second axis different from the first axis.

In one embodiment, an ultrasonic pulse is transmitted by the ultrasonic range sensor disposed above a surface, along the first axis. A distance to the surface is determined based on the reflected signal. In one embodiment, the surface is an object whose range is to be determined. For example, the surface may be a road surface or other type of surface.

In another embodiment, the deflecting region comprises a plurality of ridges disposed on a surface of the ultrasonic range sensor.

In another embodiment, the second axis is deflected from the first axis by a non-zero angle determined by a characteristic of the deflecting region.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows an ultrasonic range sensor disposed above a surface;

FIG. 2A shows an exterior surface of an ultrasonic range sensor in accordance with an embodiment;

FIG. 2B shows components of an ultrasonic range sensor in accordance with an embodiment;

FIG. 3 shows a cross section of a deflecting surface in accordance with an embodiment;

FIG. 4 shows an ultrasonic range sensor disposed above a surface in accordance with an embodiment;

FIG. 5 is a flowchart of a method of conducting an ultrasonic range sensing operation in accordance with an embodiment; and

FIG. 6 shows a cross section of a deflecting surface in accordance with another embodiment.

### DETAILED DESCRIPTION

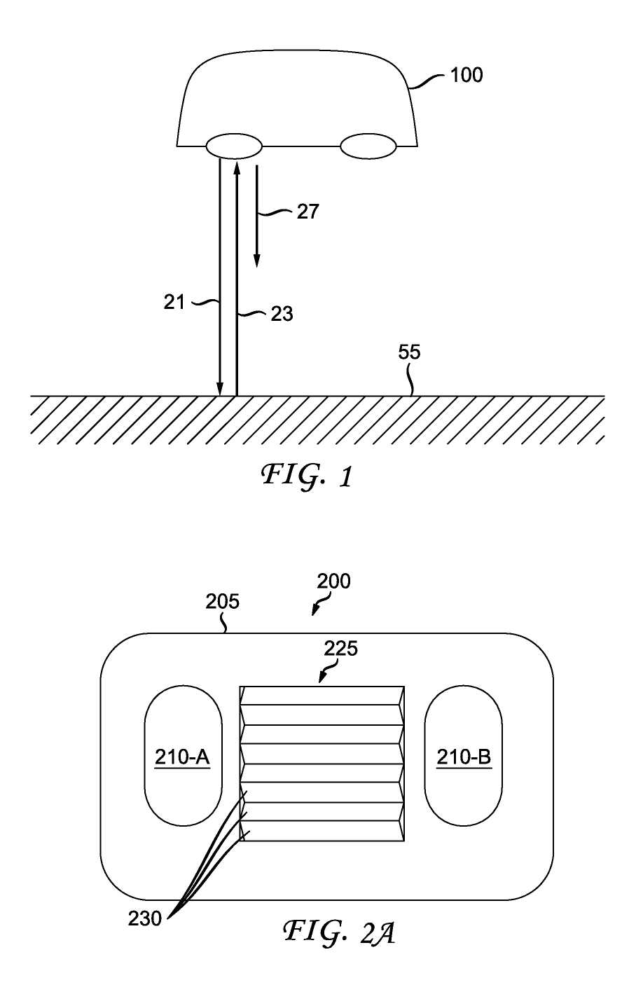

FIG. 1 shows an ultrasonic range sensor disposed above a surface. Sensor 100 is disposed above a surface 55, which may be a road surface, for example. In operation, sensor 100 emits a primary pulse 21, which strikes surface 55 and generates a reflection 23. Reflection 23 propagates from surface 55 to sensor 100 and is detected by sensor 100. Sensor 100 may calculate a distance from sensor 100 to surface 55 based on reflection 23.

Reflections associated with a primary pulse can be reflected by the surface of the sensor itself, causing transmission of a “secondary pulse” which can generate further “secondary reflections.” Referring to FIG. 1, reflection 23 is reflected from the surface of sensor 100, generating a secondary pulse 27. Secondary pulse 27 may strike surface 55 or another object in the vicinity of sensor 100 and generate a secondary reflection (not shown). Secondary reflections are generally undesired signals and, for example, can cause an ultrasonic sensor to perceive one or more false targets during an ultrasonic sensing operation. Sensor 100 may need to use processing resources to filter out secondary reflections in order to accurately measure the distance from sensor 100 to surface 55. Consequently, there is a need for improved ultrasonic range systems capable of eliminating or reducing secondary pulses and/or secondary reflections.

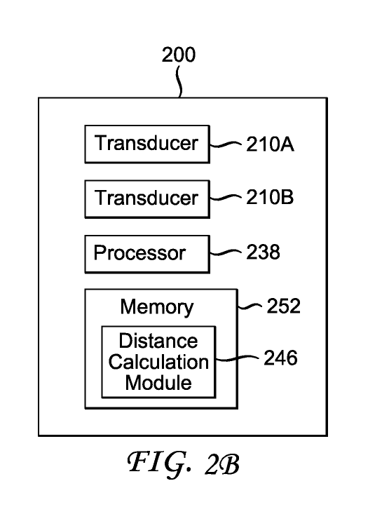

In accordance with an embodiment, an improved ultrasonic range sensor is provided. FIG. 2A shows an exterior view of an ultrasonic range sensor in accordance with an embodiment. Sensor 200 comprises an exterior surface 205 having two transducers 210-A, 210-B. Exterior surface 205 may be one side of sensor 200, for example. Exterior surface 205 also comprises a deflecting region 225. In the illustrative embodiment, deflecting region 225 comprises a set of raised, parallel ridges 230. Ridges 230 are arranged parallel to an axis extending between the centers of the faces of transducers 210-A, 210-B.

FIG. 2B shows functional components of ultrasonic range sensor 200 in accordance with an embodiment. Ultrasonic range sensor 200 comprises transducers 210-A and 210-B, processor 238, and a memory 252. Processor 238 controls the operation of various components of sensor 200. Transducers 210-A, 210-B are capable of generating ultrasonic signals and of detecting ultrasonic signals. Memory 252 stores data. For example, various components of sensor 200 may from time to time temporarily store data in memory 252.

In the embodiment of FIG. 2B, a distance calculation module 246 resides in memory 252. Distance calculation module 246 receives data from transducers 210-A and 210-B, and calculates a distance to a surface. For example, distance may be calculated based on a measured time interval between a transmission of a first ultrasonic signal and reception of a second ultrasonic signal representing a reflection of the first signal. Distance calculation module 246 may comprise a software application, for example.

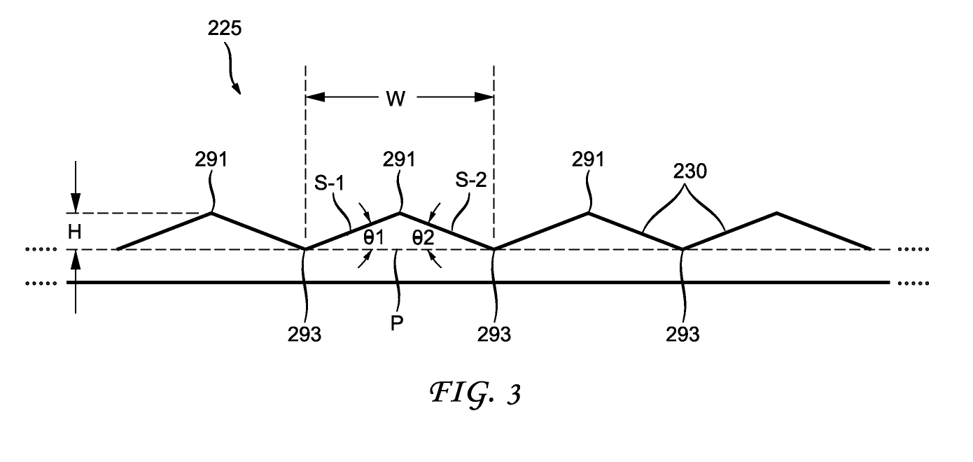

FIG. 3 shows a cross sectional view of deflecting region 225 in accordance with an embodiment. Specifically, deflecting region 225 comprises a plurality of ridges 230, each having two sloping sides S-1, S-2 intersecting at a peak 291. Two adjacent ridges 230 intersect at a valley 293. In the illustrative embodiment, ridges 230 are disposed above a plane P defined by valleys 293.

Each ridge 230 comprises a side S-1 and a side S-2. The angle between side S-1 and plane P is θ1; the angle between side S-2 and plane P is θ2. Angle θ1 may be any non-zero angle and may be determined at least in part based on one or more characteristics of deflecting surface 225, a wavelength to be used, manufacturing considerations, etc. Similarly, angle θ2 may be any non-zero angle and may be determined at least in part based on one or more characteristics of deflecting surface 225, a wavelength to be used, manufacturing considerations, etc. In some embodiments, angles θ1 and θ2 may be equal; in other embodiments, angles θ1 and θ2 may be different.

Ridges 230 have a width W representing a distance between peaks 291 of two adjacent ridges. Width W may vary. In the illustrative embodiment, ridges 230 have a uniform width W. In accordance with an embodiment, ridges 230 have a width W at least one-fourth the wavelength of the ultrasonic signal that is used by sensor 200 to determine distances. Ridges 230 have a height H, which may vary. In one illustrative embodiment, ridges have a height H of ten (10) millimeters and a width W of fifteen (15) millimeters. In some embodiments, the width W and height H of ridges 230 may be determined empirically based on factors such as environmental factors, the material used to construct sensor 200, manufacturing considerations, etc.

The location and dimensions of a deflecting region may vary. In one embodiment, ridges 230 are substantially parallel to an axis defined between the centers of the faces of transducers 210-A and 210-B. In another embodiment, a deflecting region is disposed on the surface of the ultrasonic sensor such that the axis of transmission of the ultrasonic signal produced by transducers 210 is substantially normal, or perpendicular, to plane P (defined by valleys 293). In the illustrative embodiment of FIG. 2A, deflecting region 225 substantially covers an area between transducers 210. In other embodiments, a deflecting region may cover more or less of the exterior surface of sensor 200.

FIG. 3 is illustrative and is not to be construed as limiting. In other embodiments, many different variations of the characteristics and parameters of the deflecting region of an ultrasonic range sensor are possible. In some embodiments, an ultrasonic range sensor may include a plurality of deflecting regions.

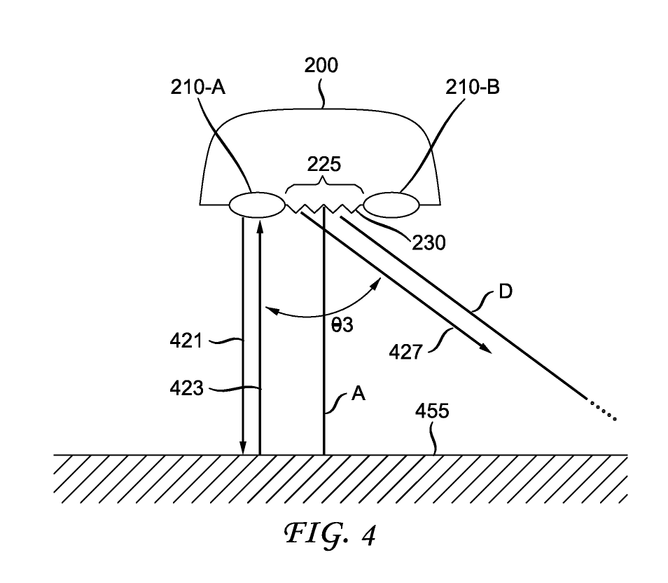

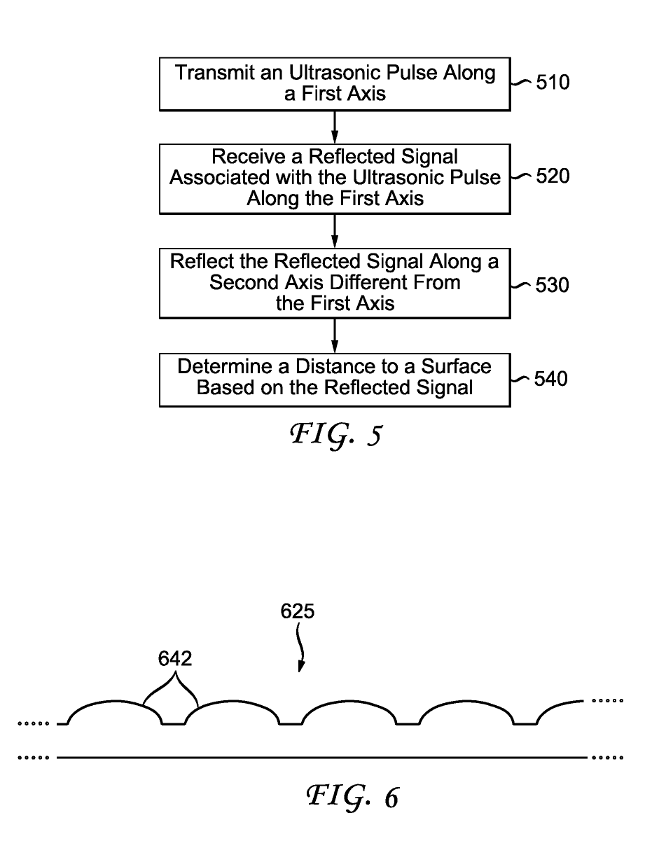

FIG. 4 illustrates ultrasonic range sensor 200 in operation, in accordance with an embodiment. FIG. 5 is a flowchart of a method of reducing secondary reflections in accordance with an embodiment. The method of FIG. 5 is discussed with reference to the embodiment of FIG. 4. Sensor 200 is disposed above a surface 455. Surface 455 is a target object for which a range is desired. For example, surface 455 may be a road surface, for example, or another type of surface.

At step 510, an ultrasonic pulse is transmitted along a first axis toward a surface. Specifically, processor 238 (of sensor 200) causes transducers 210 to generate and transmit a primary pulse toward surface 455. Accordingly, ultrasonic sensor 200 transmits primary pulse 421 along a first axis A defined between sensor 200 and surface 455. In an illustrative embodiment, first axis A is normal to plane P (shown in FIG. 3).

At step 520, a reflected signal associated with the ultrasonic pulse is received along the first axis. All or a portion of primary pulse 421 is reflected from surface 455, generating a reflected signal 423 that propagates along first axis A from surface 455 to sensor 200. In some embodiments, the reflected signal propagates and is received along an axis that is parallel to the first axis of transmission. Transducers 210 detect reflected signal 423 and provide data representing the reflected signal to processor 238.

At step 530, the reflected signal is reflected along a second axis different from the first axis. When reflected signal 423 strikes sensor 200, at least a portion of reflected signal 423 is reflected from deflecting surface 225, generating a secondary pulse 427. Due to ridges 230, secondary pulse 427 is transmitted along a second axis D deflected from the first axis by angle θ3 with respect to the first axis. Angle θ3 is a non-zero angle. In some embodiments, angle θ3 may be equal to angle θ1 or to angle θ2; in other embodiments, angle θ3 may be different from angle θ1 and angle θ2.

Because secondary pulses are deflected in the manner illustrated by FIG. 4, the quantity and intensity of secondary reflections is reduced.

At step 540, a distance to a surface is determined based on the reflected signal. Distance calculation module 246 determines, based on reflected signal 423 as detected by transducers 210, a distance between sensor 200 and surface 455. For example, distance calculation module 246 may determine a time interval between transmission of primary pulse 421 and detection of reflected signal 423, and determine a distance between sensor 200 and surface 455 based on the time interval.

In other embodiments, an ultrasonic sensor may have a deflecting region with a structure different from that shown in FIG. 3. FIG. 6 shows a deflecting region in accordance with another embodiment. Deflecting region 625 comprises a plurality of domes adapted to deflect a signal having a first axis along a second axis different from the first axis. In other embodiments, a deflecting region may include a plurality of three dimensional shapes such as domes, pyramids, etc. Such shapes may be evenly distributed on a surface or randomly distributed on the surface.

In various embodiments, the method steps described herein, including the method steps described in FIG. 5, may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. FIG. 2B shows one exemplary embodiment of a device having such components; however, in other embodiments, other types of devices having other components not shown in FIG. 2B are possible. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 5, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. An ultrasonic range sensor comprising:
at least one transducer adapted to:
generate an ultrasonic pulse having a first axis of transmission; and
detect a reflected signal associated with the ultrasonic pulse, wherein the reflected signal propagates along the first axis of transmission; and
a deflecting region adapted to reflect the reflected signal along a second axis different from the first axis of transmission.

2. The ultrasonic range sensor of claim 1, comprising two transducers.

3. The ultrasonic range sensor of claim 2, wherein the deflecting region and the two transducers are disposed on a surface of the ultrasonic range sensor, the deflecting region being disposed between the two transducers.

4. The ultrasonic range sensor of claim 1, wherein the deflecting region comprises a plurality of parallel ridges disposed on the surface, the plurality of ridges being perpendicular to the first axis of transmission.

5. The ultrasonic range sensor of claim 4, comprising a first transducer and a second transducer;
wherein the plurality of parallel ridges are parallel to a third axis between a first center of the first transducer and a second center of the second transducer.

6. The ultrasonic range sensor of claim 4, wherein:
the at least one transducer generates an ultrasonic pulse having a wavelength; and
a width of each of the plurality of ridges is at least one-fourth the wavelength.

7. The ultrasonic range sensor of claim 1, wherein the deflecting region comprises a plurality of cones.

8. The ultrasonic range sensor of claim 1, wherein the deflecting region comprises a plurality of domes.

9. The ultrasonic range sensor of claim 1, further comprising:
a processor adapted to determine a distance between the ultrasonic range sensor and a surface based on the reflected signal.

10. The ultrasonic range sensor of claim 1, wherein the second axis is deflected from the first axis by a non-zero angle determined by a characteristic of the deflecting region.

11. A method of operation of an ultrasonic range sensor, the method comprising:
transmitting an ultrasonic pulse along a first axis;
receiving a reflected signal associated with the ultrasonic pulse along the first axis; and
reflecting, by a deflecting region disposed on a surface of the ultrasonic range sensor, the reflected signal along a second axis different from the first axis.

12. The method of claim 11, further comprising:
transmitting, by an ultrasonic range sensor disposed above a second surface, an ultrasonic pulse along the first axis.

13. The method of claim 12, further comprising:
determining a distance to the second surface based on the reflected signal.

14. The method of claim 13, wherein the second surface is a target object for which a range is desired.

15. The method of claim 14, wherein the second surface is a road surface.

16. The method of claim 11, wherein the deflecting region comprises a plurality of ridges disposed on a surface of the ultrasonic range sensor.

17. The method of claim 11, wherein the second axis is deflected from the first axis by a non-zero angle determined by a characteristic of the deflecting region.
